(19) United States
(12) Patent Application Publication
(10) Pub. No.: US 2004/0169759 A1
(43) Pub. Date: Sep. 2, 2004

(54) Server and a server system

(76) Inventor: Kenichi Kikuchi, Kurume-shi (JP)

Correspondence Address: STEVENS DAVIS MILLER & MOSHER, LLP, 1615 L STREET, NW, SUITE 850, WASHINGTON, DC, 20036, US

(21) Appl. No.: 10/721,775

(22) Filed: Nov. 26, 2003

(30) Foreign Application Priority Data
Nov. 27, 2002 (JP) P.2002-343598

(51) Int. Cl. H04N 5/222; H04N 5/232; H04N 7/01

(52) U.S. Cl. 348/333.12; 348/211.3; 348/458; 348/459; 348/207.1

(57) ABSTRACT

Displaying a subject image on a browser in accordance with the aspect ratio of the subject image, with reduced scan line interference at a time exposure, as well as transmitting a high-quality image with easy compression processing.

A server according to the invention compresses, in a predetermined operating state, only a image signal in either a first or second field and transmits the-resulting signal to a browser in a network terminal. This reduces scan line interference thus upgrading for example the picture quality obtained at a time exposure. In response to an access from the browser in the network terminal, the server transmits to the browser the information containing link information for image data and an image information display size instruction described in a markup language so as to match the aspect ratio of the displayed image with that of the subject image.

CROSS REFERENCE TO RELATED APPLICATION

This application is based upon and claims the benefit of priority of Japanese Patent Application No2002-343598 filed on Nov, 27, 2002, the contents of which are incorporated herein by reference in its entirety.

### BACKGROUND OF THE INVENTION

1. Field of the Invention

The present invention relates to a server which transmits to a browser only an image in one field and display information to interpolate data insufficient on the browser display thus displaying the data when scan line interference is noticeable, a server system using the server, and a method for transmitting a camera image over a network and displaying the camera image.

2. Description of the Related Art

In case an image shot with a TV camera is displayed on a display, the image is converted to an electric signal by scanning the image with a plurality of scan lines. It is well known that there are two types of this scanning method. One is the interlaced scan and the other is the progressive scan. The interlaced scan performs a first scan on an image with odd-numbered scan lines and a second scan on the image with even-numbered scan lines before the image is displayed. The progressive scan displays an image by updating all scan lines in one pass. The scan interval between an odd field and an even field and between an even field and an odd field for the interlaced scan is typically 1/60 of a second while the frame interval of the progressive scan is a 1/30 of a second.

The interlaced scan performs scan twice at an interval of 1/60 of a second because, in case the image is displayed at double intervals, that is, at intervals of 1/30 of a second, the afterimage effect of human eyes is weakened and the picture quality obtained is degraded due to flicker. In the interlaced scan, every other horizontal line is scanned in one pass. A single screen is divided into two fields, which are displayed with two scans. Thus, interlaced scan on a fast-moving image will result in scan line displacements caused by a difference in time between two scan line fields. When an image is photographed with the interlaced scan system and the image is displayed as a moving image on a display unit through the interlaced scan, the scan line displacements are not very noticeable. When the image is displayed as a still image such as a JPEG image, the scan line displacements are highly noticeable. This problem is specific to the interlaced scan which has a different procedure from that of the progressive scan.

In this way, in case a moving subject is switched from a moving image to a still image in photographing during the interlaced scan, a moving portion is accompanied by the scan line displacements caused by a time difference of 1/60 of a second. This problem is previously addressed by the automatic frame/field switching apparatus according to the Japanese Patent Laid-Open No. 179889/1991. FIG. 6 is a block diagram of related art automatic frame/field switching apparatus. In FIG. 6, a numeral 101 designates a first field memory, 102 a second field memory, 103 a motion detector, and 104 a selector.

Digital image signals converted from analog signals are input to the automatic frame/field switching apparatus. The pixel data of a image signal in the first field is stored in the first field memory 101 and the pixel data of a image signal in the second field is stored in the second field memory 102. The pixel data of the stored in these field memories is transmitted to the selector 104. The motion detector 103 performs threshold value processing on the difference value between predetermined pixel data stored in the first field memory 101 and predetermined pixel data stored in the second field memory 102 to detect the presence of displacements of the image. The selector 104, receiving a detection signal to indicate that such displacements of the image are absent, outputs a digital image signal obtained by synthesizing the pixel data stored in the first field memory 101 and the pixel data stored in the second field memory 102. The selector 104, receiving a detection signal to indicate that such displacements of the image are present, selects either the first field or second field and outputs a digital image signal synthesized to display the lines in the pixel data twice.

In this way, the automatic frame/field switching apparatus according to the Japanese Patent Laid-Open No. 179889/1991 is capable of transmitting a still image free from displacements of the image. The apparatus uses only one of the fields to perform encoding for data transmission, which means that the time required for encoding is reduced to half thus improving the transmission efficiency.

It is a common practice to obtain an image from a network camera via a network such as the Internet by using a network terminal such as a PC, PDA or a cell phone. An image pickup device mounted on the network camera used to obtain image data now uses the interlaced scan system almost without exception. Thus the aforementioned displacements of the image and scan line interference to make noticeable the scan line structure are troublesome on the display. Further, relationship between the number of pixels of an image pickup device and the processing for image display results in the mismatch the size of the photographed image and the size of the image on a display.

That is, a image signal obtained from the image pickup device of a camera is processed with a same clock as that for the sampling dots of the pixels of the image pickup device. Thus, the number of samples of the image signals obtained is the same as the number of pixels of the image pickup device. The image signal thus obtained is compressed before it is transmitted and displayed in the number of samples. In this practice, the pixel pitch on a network terminal is the same in the vertical and horizontal directions with some exceptions, while the area size of an image pickup device is generally unequal in the vertical and horizontal directions. This generates unexpected distortion in the displayed image. For example, an image pickup device having 746×480 pixels processed with a 4fsc clock has an aspect ratio of 3:2. Transmitting the data of an image photographed with such an image pickup device and displaying the image on a network terminal display in 746×480 pixels provides a distorted oblong image.

As mentioned hereinabove, when an image is photographed with a network camera of the interlaced scan system and transmitted to a network terminal, the displacements of the image present a problem. Moreover, there is a mismatch between the size of the photographed image and the size of the displayed image on a display. Another problem is that data transmission takes time when a traffic load on the network is heavy.

In case photographing is made on a server such as a network camera, environmental conditions for photographing may vary. For example, in an environment where photographing sensitivity is low, such as at nighttime, mode setting is required to perform a time exposure. In this mode, the interval between image frames shot with an image pickup device is longer than 1/30 of a second. In such a state, time difference between the first field and the second field is large in the interlaced scan. This reveals the structure of scan lines on a display, a phenomenon called scan line interference.

On the frame/field switching apparatus according to the Japanese Patent Laid-Open No. 179889/1991, the magnitude of the displacements of the image is determined using a threshold value in image processing. An image obtained in the time exposure mode has considerably degraded picture quality caused by inevitable scan line interference. The image obtained is distorted in terms of the aspect ratio due to the difference between the area size of an image pickup-device and the pixel pitch of a display. These are two major causes of picture quality degradation in the time exposure mode.

### SUMMARY OF THE INVENTION

In view of the relates art problems, the invention aims at providing a server and a server system capable of displaying a subject image on a browser in accordance with the aspect ratio of the subject image, with reduced scan line interference at a time exposure, as well as transmitting a high-quality image with easy compression processing.

In order to solve the problems, the invention provides a server comprising: a camera section for photographing a subject image by way of imaging means of the interlaced scan system and outputting image signals in a first field and a second field; image signal compress ion means for compressing the image signals output from the camera section; a network interface for transmitting image data encoded by the image signal compression means to a network; and a controller for controlling the camera section and the image signal compression means; characterized in that the server is equipped with communications means for transmitting a web page describing link information for the image data and a display instruction in a markup language in order to display the information and the instruction on a browser installed in a network terminal and that the server, when transmitting a image signal in either the first field or the second field, transmits a web page describing a display instruction to display image information at the same aspect ratio as that of a subject image.

It is thus possible to display image information on a browser in accordance with the aspect ratio of a subject image, with reduced scan line interference at a time exposure, as well as transmit a high-quality image with easy compression processing.

Further, the invention provides a server which transmits to the browser the information containing link information for image data and an image information display size instruction described in a markup language, characterized in that, in response to an image information transmission request from the network terminal in accordance with the description of the information, the server compresses, in a predetermined operating state, a image signal in either the first or second field on the image signal compression means, and that the server, except in the predetermined operating state, synthesizes and compresses image signals in the first and second fields on the image signal compression means before transmitting the resulting signal to the network terminal. Thus, in a predetermined operating state, it is possible to transmit a image signal in either the first or second field thereby upgrading the picture quality and facilitating data compression. Except in the predetermined operating state, it is possible to output image signals in the first and second fields by way of imaging means of the interlaced scan system. In this way, it is possible to automatically reproduce a subject image through interpolation by the browser even when the fields are switched over.

### BRIEF DESCRIPTION OF THE DRAWINGS

FIG. 1 is a block diagram of a server system according to Embodiment 1 of the invention;

FIG. 2 is a block diagram of a server according to Embodiment 1 of the invention;

FIG. 3 is an explanatory drawing of the interlaced scan system;

FIG. 4 is an explanatory drawing of a process from compression of a frame image in accordance with each mode to display of the frame image on a browser;

FIG. 5 is an explanatory drawing of the operation mode; and

FIG. 6 is a block diagram of related art frame/field switching apparatus.

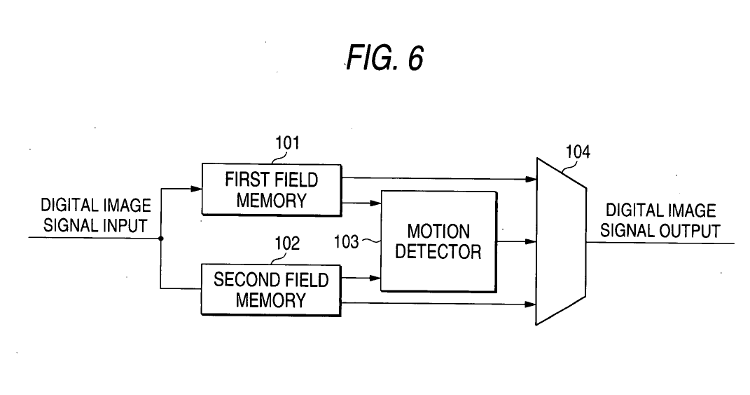

### DESCRIPTION OF THE PREFERRED EMBODIMENTS

Embodiments of the invention are detailed below with reference to attached drawings.

(Embodiment 1)

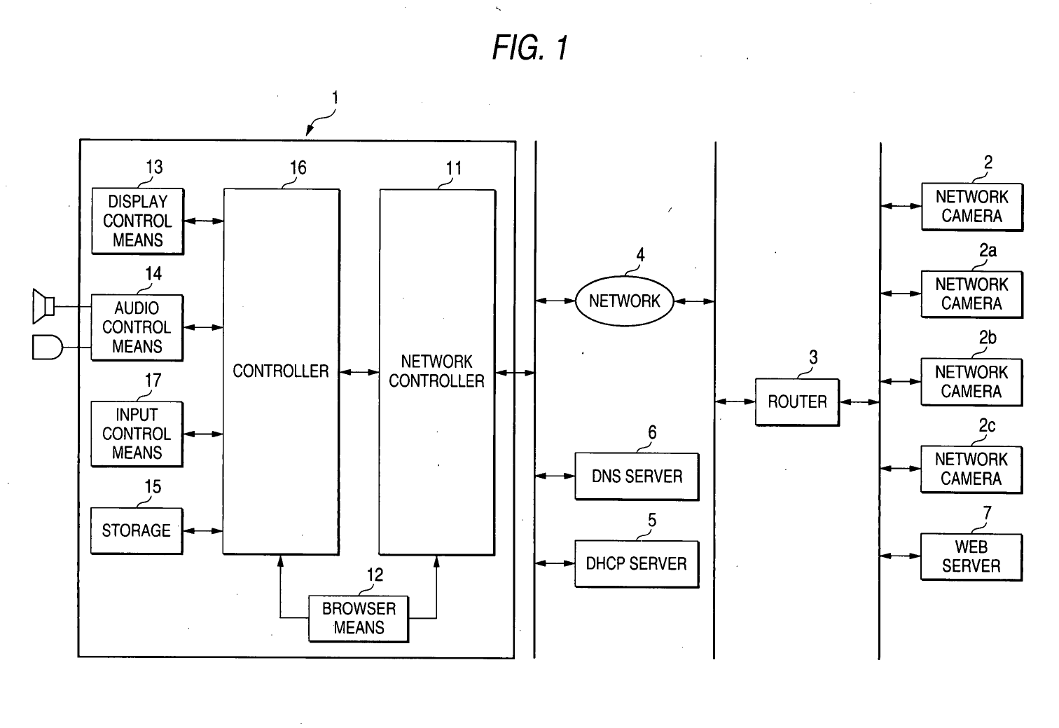

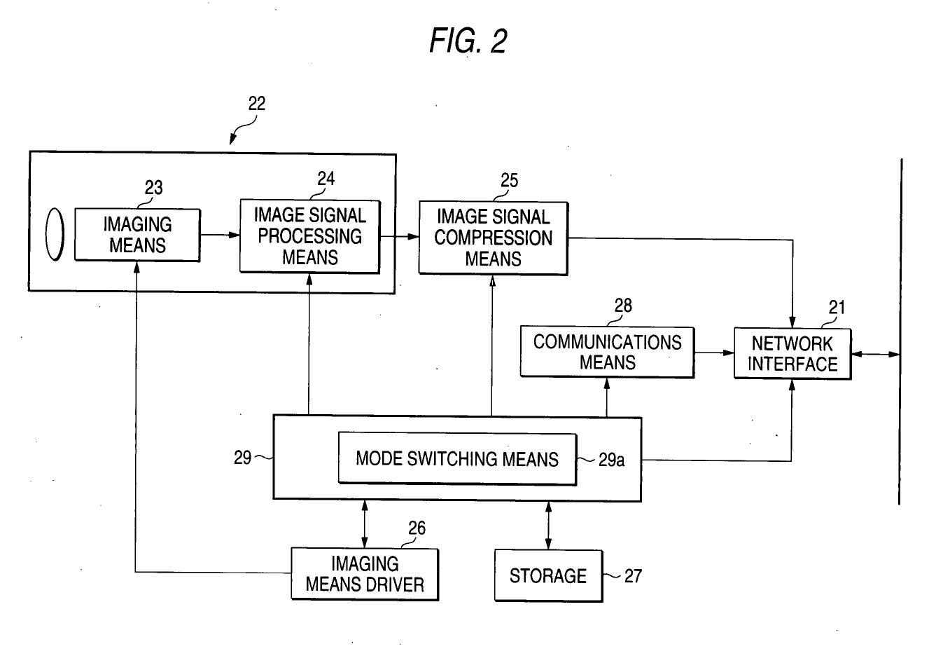

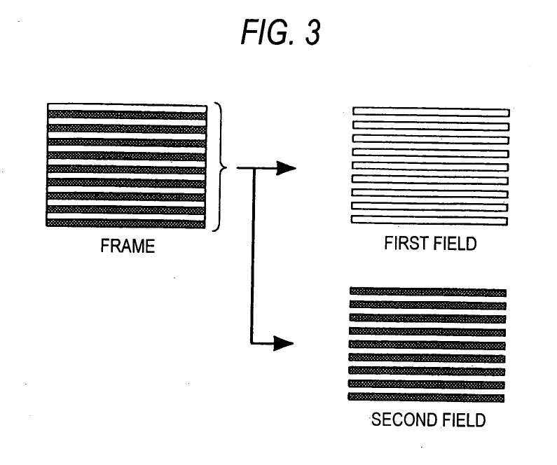

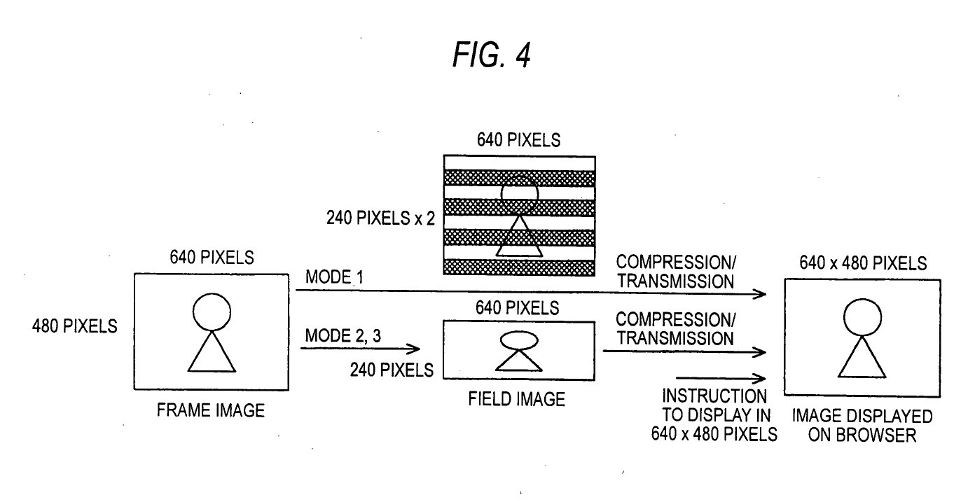

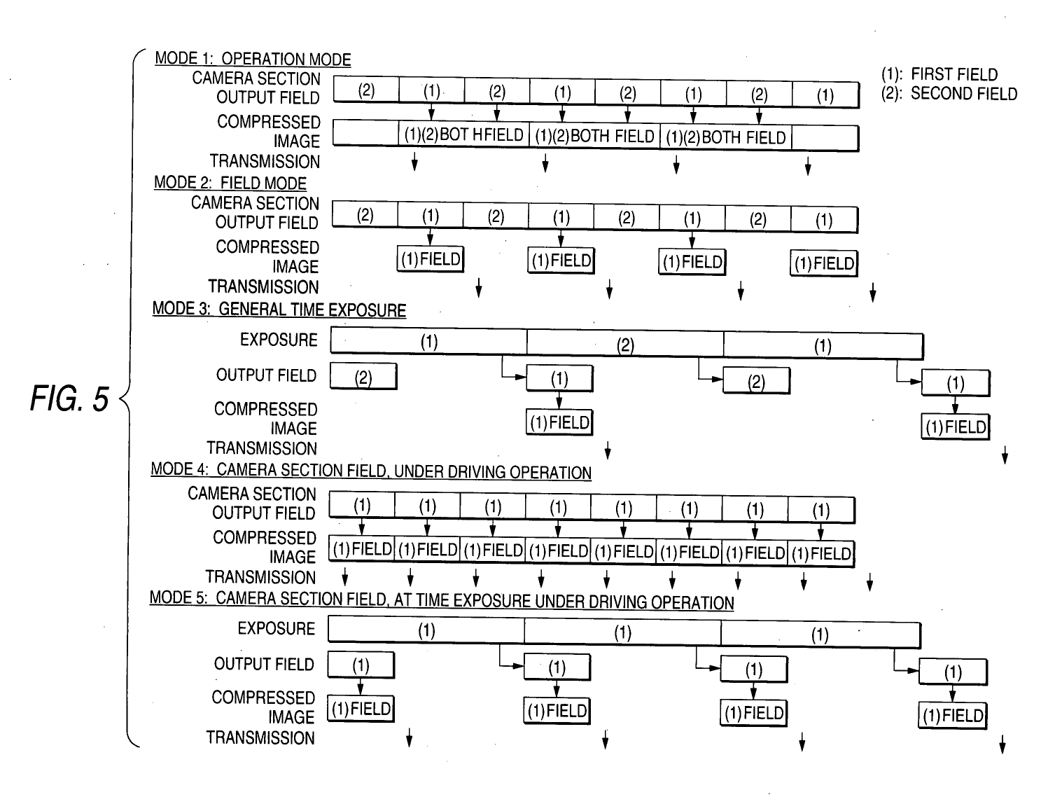

A server system, a server thereof, and a method for transmitting a camera image over a network and displaying the camera image according to Embodiment 1 of the invention are described below. FIG. 1 is a block diagram of a server system according to Embodiment 1 of the invention. FIG. 2 is a block diagram of a server according to Embodiment 1 of the invention. FIG. 3 is an explanatory drawing of the interlaced scan system. FIG. 4 is an explanatory drawing of a process from compression of a frame image in accordance with each mode to display of the frame image on a browser. FIG. 5 is an explanatory drawing of the operation mode.

In the entire configuration of a network camera system (a server system of the invention) shown in FIG. 1, a numeral 1 designates a network terminal such as a PC for displaying an image on a display, 2, 2a, 2b, 2c network cameras (servers of the invention) having a server function for transmitting a web page where an image is embedded from the network terminal 1 in response to an access, 3 a router which exerts control over the network cameras 2, 2a, 2b, 2c, and 4 a network such as the Internet. A numeral 5 designates a DHCP server for assigning a global IP address to the network terminal 1 in accordance with an IP address assignment request from the network terminal 1, and 6 a DNS server for transmitting an IP address of a host name inquired about to the network terminal 1 in response to a name resolution inquiry from the network terminal 1. A numeral 7 designates a web server capable of downloading plug-in software for extending a browser function to play back a moving image to the network terminal 1.

In this network camera system, when the network camera 2a, 2b, 2c are accessed, or requested to transmit a web page by browser means 12 installed in the network terminal 1 by way of the HTTP protocol, by using a destination URL as a host name and a port number of the network camera, the network terminal 1 acquires a global IP address from the DNS server 6 and transmits to the router 3 a data packet with the acquired IP address embedded in the destination header of the IP packet and a port number in a TCP header. The router 3 makes port forwarding of the data packet in accordance with the port number embedded in the TCP header to transmit the data packet to the network cameras 2a, 2b, 2c. The network camera 2, in response to the access from the network terminal 1, transfers a web page where an image is appended, or link destination path is described, to the network terminal 1 via the router 3 and the network 4.

The internal configuration of the dispersed network camera system, first of all, the network terminal 1 will be described. In FIG. 1, a numeral 11 designates a network controller for controlling communications between the network terminal 1 and the network 4. A numeral 12 designates browser means which, accessing a server connected to the network 4 such as the Internet via the network controller 11, receives-a page of an HTML or XTML file and regenerates the page on a display. HTML and XTML are markup languages used to display a web page by way of a protocol such as HTTP.

As shown in FIG. 1, a numeral 13 designates display control means for displaying a received image file or another image file such as a moving image on a display, 14 audio control means for regenerating a received audio file or another audio file. The audio control means 14 and the display control means 13 may be incorporated from the web server 7 in order to extend the function of the browser means 12. The browser means 12, receiving an HTML file or an XTML file, operates the display control means 13 to regenerate an image.

A numeral 15 designates a storage for storing various control programs and various data. A numeral 16 designates a controller for controlling the network terminal 1. The controller 16 comprising a CPU works as function implementation means for reading a control program corresponding to each function from the storage 5 and executing the program. Anumeral 17 designate input control means for input via a mouse and a keyboard.

The network camera 2 of the network camera system will be described. In FIG. 2, a numeral 21 designates a network interface between the network camera 2 and the network 4. The network interface 21 communicates a request from the browser of the network terminal 1 to the network camera 2 and transmits a file described in a markup language, that is, file-format information as well as information of any format which can be transmitted for display on the browser, to the network 4. A numeral 22 designates a camera section, 23 imaging means for performing photoelectric conversion such as a CCD or CMOS image pickup device provided in the camera section 22, 24 image signal processing means for processing R, G, B signals as image signals from the imaging means 23 or a complementary signal and generating a luminance signal Y and Cr, Cb signals as color difference signals. The image signal processing means performs CDS (Correlated Double Sampling), contour correction, gamma correction, matrix correction and white balance processing.

A numeral 25 designates image signal compression means for capturing the luminance signal Y and the Cr, Cb signals as color difference signals output from the image signal processing means 24 with a predetermined timing and compressing theses signals in the JPEG format, MPEG format, or other formats. The image signal compression means typically quantizes and encodes a DCT-processed signal and appends a predetermined header to the resulting signal. A numeral 26 designates an imaging means driver for outputting a drive signal for the imaging means 23.

A numeral 27 designates a storage for storing a plurality of files where a display instruction and link information are described in a markup language. The files previously stored may be modified by way of external remote operation via the network interface 21. A new file maybe downloaded. A numeral 28 designates communications means for fetching a file described in HTML (information according to the invention) from the storage 27 and transmitting the file to the browser. The communications means 28 may dynamically generate a file for displaying a web page corresponding to a request from the browser and transmit the file to the browser. A numeral 29 designates a controller which works as function implementation means for loading a control program into a Central Processing Unit (CPU) to implement the functions. The controller 29 processes a request from the browser and operates the communications means 28 to generate a file for a web page, fetches from the storage the image data to be transmitted to the browser, and specifies the drive mode to the imaging means driver 26 to operate the same.

(Description of imaging operation)

The operation of the network cameras 2, 2a, 2b, 2c is described below. Receiving a request from the browser via the network 4, the controller 29 operates the imaging means driver 26 and the imaging section 23 executes photography. Image signals such as R, G, B signals which have undergone photoelectric conversion by the photography with the imaging section 23 are processed by the image signal processing means, and converted to the luminance signal Y and the Cr, Cb signals as color difference signals. an image pickup device comprising the imaging means 23 is an image pickup device of the interlaced scan system. As shown in FIG. 3, a image signal interlaced by alternate scan on odd-numbered lines and even-numbered lines is generated by the imaging means driver 26. A signal obtained by scanning the odd-numbered lines corresponds to the image information in the first field (odd field) and a signal obtained by scanning the even-numbered lines corresponds to the image information in the second field (even field).

At a normal exposure, image information in the first and second fields comprises a single frame which is then subject to image compression.

A state for example during panning or tilting operation of the camera section 21 or a state assumed when traffic load is high is determined by the controller 29 and image information on either the first field or second field is compressed and the compressed data is transmitted to the network in order to prevent a delay in processing.

At a time exposure, for example only the image information in the first field is compressed and transmitted to the network 4. In the case of a time exposure, the imaging time difference between the first field and the second field is large so that the scan line interference on a moving portion increases to degrade the picture quality. The scan line interference can be prevented and the picture quality is maintained high by compressing the image information on either field alone and transmitting the resulting information to the network 4.

Thus, in Embodiment 1, mode setting is made to support a case where the exposure state and panning/tilting operation are considered to support a case where image data is compressed and transmitted frame by frame and a case where send field data is compressed and transmitted as a unit of send information. As shown in FIG. 5, Mode 1 through Mode 3 set in Embodiment 1 uses the controller 29 to compress the output from the camera section 21 in three modes.

Mode 1 of Embodiment 1 (first mode of the invention) is a frame mode which synthesizes the image information in the first field and the second field to compose a single frame and perform image compression. This mode uses the normal exposure and the time of exposure is as long as the time to read each field. Mode 2 is a field mode which compresses the image information on either the first or second field. This mode also uses a normal exposure and the time of exposure is as long as the time to read each field. In Mode 2, the controller 29 instructs the image signal compression means 25 to compress only one field when for example traffic load is high.

Mode 3 is a field mode whose time of exposure is changed from the normal exposure (1/60 of a second) to the time exposure (for example 1/20 of a second). In the camera section 21, an exposure of 1/60 of a second is made per field and the image information in the first and second fields is output. The controller 29 instructs the image signal compression means 25 to compress only one field (the first field in this example) and only the compressed image in the first field is transmitted.

A series of processing up to the browser assumed when a frame image is transmitted in Mode 1 through Mode 3 will be described referring to FIG. 4. FIG. 4 is an explanatory drawing of a process from compression of a frame image in accordance with each mode to display of the frame image on a browser.

The browser which has accessed the server receives an HTML file described in a markup language transmitted from the server in response to the access. The HTML file describes link information to obtain image information and a display instruction (size and position) of the image information obtained. The browser makes a transmission request for an image from the server based on the link information. In case the server is in the normal state, the link information describes a request of continuous transmission of the image in Mode 1 so that the browser requests the server to transmit the image in Mode 1. Receiving the request, the server, as shown in FIG. 3, transmits information obtained by synthesizing and compressing the image information (640×280 pixels×2) in the first and second fields. The browser, receiving the image information, regenerates the image as browser display (640×480 pixels) based on a display instruction to display the image in 640×480 pixels described in the HTML file. Images are continuously transmitted from the server and the browser receives the images and sequentially displays them.

Mode 2 will be described. In case a drive instruction (panning or tilting) button on the imaging means 23 of the server displayed as GUI on a web page is pressed while the browser is displaying the web page from the server, a request to drive the imaging means 23 is transmitted from the browser to the server. The server, determining that the information on driving the imaging means is received, uses the controller 29 to request the imaging means driver 26 to drive the imaging means 23. The imaging means driver 26 drives the imaging means 23 in response to the request. The controller 29 also requests the image signal compression means 25 to compress only the image information in the first field to generate image information. Receiving the information, the image signal compression means 25 compresses only the information in the first field (640×240 pixels) to generate image information. The controller 29 transmits the information to the browser via the network interface 21. The browser, receiving the image information, interpolates the scan line information in the vertical direction of the first field and displays the image information (640×480 pixels) based on a display instruction (an instruction to provide display in 640×480 pixels) described in the HTML file previously received. When panning/tilting operation is over, the controller 29 requests the image signal compression means 25 to synthesize and compress the image information in the first and second fields (640×280 pixels×2). Then control returns to Mode 1. It is thus possible to use only the information in a single field in the interlaced scan system by way of the image signal compression means 25 to prevent possible degradation of picture quality in the interlaced scan system, without changing the image size displayed on a browser, that is, an HTML file operating on a browser, even during panning/tilting operation.

Mode 3 will be described. In case a time exposure button of the server displayed as GUI on a web page is pressed while the browser is displaying the web page from the server, a request to make a time exposure is transmitted from the browser to the server. The server, determining that a time exposure request is received, uses the controller 29 to request the imaging means 23 to make a time exposure. The imaging means 23 makes a time exposure (for example scanning on a single field for 1/20 of a second). The controller 29 also requests the image signal compression means 25 to compress only the image information in the first field to generate image information. Receiving the information, the image signal compression means 25 compresses only the information in the first field (640×240 pixels) to generate image information. The controller 29 transmits the information to the browser via the network interface 21. The browser, receiving the image information, interpolates the scan line information in the vertical direction of the first field and displays the image information (640×480 pixels) based on a display instruction (an instruction to provide display in 640×480 pixels) described in the HTML file previously received. This operation continues until the time exposure halt button of the server displayed as GUI on a web page is pressed. In case the time exposure halt button is pressed, a request to halt a time exposure is transmitted to the server from the browser. The controller 29 of the server, receiving the request, requests the imaging means 23 to halt the time exposure as well as requests the image signal compression means 25 to synthesize and compress the image information in the first and second fields (640×280 pixels×2). Then control returns to Mode 1. It is thus possible to use only the information in a single field in the interlaced scan system to prevent possible degradation of picture quality in the interlaced scan system, without changing the image size displayed on a browser, that is, an HTML file operating on a browser, even during panning/tilting operation.

In case specification is made to display a predetermined frame image (640×480 pixels) in HTML in the image size of 640×480 pixels, the specification is enabled by describing<IMG SRC=“image.jpg”WIDTH=“640”HEIGHT=“480”> in a file to display a web page. Note that “image.jpg” represents an image file name. “SRC” describes a path (link information of the invention) such as a relative URL or an absolute URL to link the image file. The link is provided by specifying an image file name alone in this example.

While panning or tilting operation or a time exposure is requested in this embodiment, a case is possible where the degree of motion is detected from an image photographed with imaging means and the image signal compression means 25 may be requested to compress only the image information in the first field to generate image information based on the degree of motion.

On a server allowing accesses from a plurality of browsers, all the image information transmitted to a plurality of browsers during time exposure operation is the image information in Mode 3 (in the first field) in this embodiment. The image information in the first field alone may be transmitted to a browser only which has specified a time exposure and the image information in Mode 1 may be transmitted to the other browsers. To be more precise, the IP address and the port number of a browser which has specified a time exposure are stored and the image information in Mode 3 is transmitted to the IP address and the port number.

While the first field is used in Mode 2 and Mode 3 in this embodiment, the second field may be used as well.

Transition to Mode 3 may be determined based on GUI specification as well as for example the brightness or image signal level on the camera side for automatic transition.

On the imaging means 23, even in case the aspect ratio of the imaging area dimensions is the same as the aspect ratio of the displayed image and the aspect ratio of the number of pixels differs from the number of pixels of the displayed image, the image is correctly displayed without being distorted at the same aspect ratio as that of the image photographed with the image pickup device by specifying that a predetermined image should be displayed on a browser in the image size having the same aspect ratio as that of the imaging area dimensions. For example, assume a case where the number of pixels of the imaging means 23 for photographing an original image is 746×480 and the aspect ratio of the imaging area is 2:3, that is, in case the vertical dimension of a pixel is larger than the horizontal dimension of the pixel. The image is processed and transmitted based on the number of pixels equivalent to that of the imaging means 23. When the image data received is displayed, an oblong screen appears whose aspect ratio of the area is 480:765=5:8. When specification is made to display on a browser a predetermined image so that 480×3/2=640 pixel data in the horizontal direction will appear in the image size of 640×480 pixels in HTML format based on the number of pixels in the vertical direction, the image is correctly displayed at the same aspect ratio as that of the image photographed with an image pickup device. This technique is applicable to the progressive scan imaging as well as the interlaced imaging.

(Embodiment 2)

A server system, a server thereof, and a method for transmitting a camera image over a network and displaying the camera image according to Embodiment 2 of the invention are described below.

The server and a method for transmitting its camera image over a network and displaying the camera image according to Embodiment 2 of the invention correspond to Mode 4 and Mode 5 shown in FIG. 5. In Mode 4, when a image signal of an image photographed with the imaging means 23 on the image signal processing means 24 is processed, only a signal scanned on the imaging means 23 by using odd-numbered scan lines is output as image information in the first field, as shown in FIG. 3.

Mode 5 is a field mode of Mode 4 where a normal exposure has been changed to a time exposure. An exposure is repeated on the first field by the camera section 21. When the exposure is over, the image information in the first field is output. The controller 29 causes the imaging means 23 to photograph only the first field, not the second field so that conversion of image information between the first field and the second field is not required and only the information in one field is compressed by the image signal compression means 25, thereby enhancing the frame rate. Mode 5 and Mode 5 correspond to the second mode of the invention.

In this way, a server system, a server thereof, and a method for transmitting a camera image over a network and displaying the camera image according to Embodiment 2 of the invention scans only one field of an image pickup device of the interlaced scan system. This increases the frame rate and reduces the time required for encoding about by half as well as transmits a high-quality moving image thereby improving the transmission efficiency.

Mode change from Mode 1 through 3 to Mode 4 or Mode 5 is readily made by changing a drive signal on the imaging means driver 26.

As mentioned hereinabove, the server of the invention comprises a camera section for photographing a subject image by way of imaging means of the interlaced scan system and outputting image signals in the first field and the second field. The server captures an operated image in either the first field or the second field in a predetermined operating state and compresses only a image signal in the field to transmit the compressed signal to a network terminal. This processing suffers from smaller amount of scan line interference even at a time exposure thus upgrading the picture quality and facilitating the compression processing.

Transmitting only an image in one field means that the number of scan lines is reduced by half. This will provide an image reduced to half in the vertical direction. To solve this problem, a display instruction is issued to a browser to display the image data at the same aspect ratio as that of the subject image, thereby displaying the subject image correctly through interpolation by the browser.

The imaging means of the interlaced scan system of the invention outputs image signals in both the first field and the second field except in a predetermined operating state. In this way, it is possible to automatically reproduce a subject image through interpolation by the browser even when the fields are switched over.

When a normal exposure is switched to a time exposure, displacements of the image or scan line interference will occur inevitably. By automatically switching between modes, it is possible to transmit a quality image without any manipulation. When the position of the camera section is controlled, displacements of the image or scan line interference will also occur inevitably. By automatically switching between modes, it is possible to transmit a quality image without any manipulation.

The imaging means of the interlaced scan system of the invention can output image signals in both the first field and the second field or a image signal in one of the fields. Thus, in the presence of displacements of the image or scan line interference, it is possible to transmit a image signal in either the first field or the second field thus upgrading the picture quality and facilitating the compression processing. In this practice, communications means issues a display instruction to a browser to display the image data at the same aspect ratio as that of the subject image, thereby displaying the subject image correctly through interpolation by the browser.

When a image signal in the first field and the second field are to be output, a markup language may be used to describe a display instruction. Even in case a markup language is not used, the browser can regenerate image data at the same aspect ratio as that of the subject image. Mode switching means may be used to automatically switch between a second mode where image signals in both fields are output and a first mode where a image signal in one field is output.

When a normal exposure is switched to a time exposure, displacements of the image or scan line interference will occur inevitably. By automatically switching between modes, it is possible to transmit a quality image without any manipulation. When the position of the camera section is controlled, displacements of the image or scan line interference will also occur inevitably. By automatically switching between modes, it is possible to transmit a quality image without any manipulation.

Use of HTML or XTML being a language most general for a protocol allows interpolation by the browser without exception. Only one of the image signals in the first field and the second field which can be obtained by the imaging means of the interlaced scan system is output. This facilitates the compression processing and reduces the time required for encoding about by half as well as increases the frame rate thereby improving the transmission efficiency.

The server system of the invention can synthesize image signals in the first and second fields and output the resulting signal, or output only a image signal in one field. Thus, in the presence of displacements of the image or scan line interference, it is possible to transmit a image signal in either the first field or the second field thus upgrading the picture quality and facilitating the compression processing. In this practice, a display instruction is issued to a browser to display the image data at the same aspect ratio as that of the subject image, thereby displaying the subject image correctly through interpolation by the browser.

The method for transmitting a camera image over a network and displaying the camera image according to the invention can partially transmit the information in one field by way of imaging means of the interlaced scan system. Thus, in the presence of displacements of the image or scan line interference, it is possible to transmit only the image information in one field thus upgrading the picture quality and facilitating the compression processing. In this practice, a display instruction is issued to a browser to display the image data at the same aspect ratio as that of the subject image, thereby displaying the subject image correctly through interpolation by the browser.

What is claimed is:

1. A server, connected to a network terminal via a network, comprising:
a camera section, which photographs a subject image by a image-pickup means of the interlaced scan system and output image signals in a first field and a second field; and
a image signal compressor, which compresses the image signals output from the camera section,
wherein, in the predetermined operating state, the image signal compressor compresses only a image signal in either the first field or second field and the server transmits the compressed signal to the network terminal.

2. The server according to claim 1,
wherein the server transmits the information containing link information for image data and an image information display size instruction described in a markup language to the network terminal, in order to display a web page on a browser in the network terminal,
in case where a request for transmitting the image data is received from the network terminal in accordance with the information,
the server compresses, in a predetermined operating state, a image signal in either the first field or second field on the image signal compressor, and
the server, except in the predetermined operating state, synthesizes and compresses image signals in the first filed and second field on the image signal compressor, and
the server transmits the compressed signal to the network terminal.

3. The server according to claim 2, wherein the image information size display instruction is to make the image signal displayed at the same aspect ratio as that of a subject image.

4. The server according to claim 1, wherein the predetermined operating state is an imaging state by the camera section with long time exposure.

5. The server according to claim 1, wherein the predetermined operating state is a state of panning or tiling operation of the camera section.

6. A server comprising:
a camera section, which photographs a subject image by a image-pickup means of the interlaced scan system and outputs image signals in a first field and a second field;
a image signal compressor, which compresses the image signals output from the camera section;
a network interface, which transmits image data compressed by the image signal compressor to a network; and
a controller, which controls the camera section and the image signal compressor;
wherein the server is equipped with communicator, which transmits the information containing link information for image data and an image information display size instruction described in a markup language in order to display a web page on a browser in a network terminal; and
in case where a request for transmitting the image data is received from the network terminal in accordance with the link information,
the server transmits, in a predetermined operating state, a image signal in either the first field or second field.

7. The server according to claim 6, wherein the image information display size instruction is an instruction to display image information at the same aspect ratio as that of a subject image.

8. The server according to claim 6, the server comprising mode switch, wherein the mode switch makes mode switch over between a first mode where image signals in the first field and second field are synthesized and compressed as a frame signal before the resulting signal is output and a second mode where only a image signal in the first field and second field is compressed before the resulting signal is output.

9. The server according to claim 8, wherein in case where the mode switch has switched from a normal exposure to a long time exposure, the server switches from the first mode to the second mode.

10. The server according to claim 7, wherein, in case where the mode switch controls the position of the camera section, the server switches from the first mode to the second mode.

11. The server according to claim 3, wherein the image information display size instruction to display image information at the same aspect ratio as that of a subject image is an image information display size instruction to display image information at the same aspect ratio as that of the imaging area of an image pickup device.

12. The server according to claim 2, wherein the markup language is HTML.

13. The server according to claim 6, wherein the camera section for photographing a subject image by way of imaging means of the interlaced scan system and outputting image signals in a first field and a second field is replaced with a camera section for photographing a subject image by way of imaging means of the interlaced scan system and outputting a image signal in either a first field or a second field.

14. A server system comprising a server according to claim 6,
wherein the network terminal receives a web page transmitted from the server and regenerates image data at the same aspect ratio as that of a subject image.

15. A method for transmitting a camera image via a network and displaying the camera image, comprising the steps of:
photographing a subject image by image pickup-means of the interlaced scan system;
transmitting the image information of a subject image to a network terminal;
transmitting a file which describes in a markup language a display size instruction to display image information at the same aspect ratio as that of the subject image;
transmitting partially a field information among the image information in order to display the subject image on the network terminal.
